(19) United States
(12) Patent Application Publication
(10) Pub. No.: US 2016/0335672 A1
(43) Pub. Date: Nov. 17, 2016

(54) INTERCEPTION OF COMMUNICATIONS AND GENERATION OF SUPPLEMENTAL DATA IN CLOSED SYSTEMS

(71) Applicant: Gilbarco Inc., Greensboro, NC (US)

(72) Inventor: Tal Reichert, Medford, MA (US)

(21) Appl. No.: 15/218,440

(22) Filed: Jul. 25, 2016

Related U.S. Application Data
(63) Continuation of application No. 13/938,489, filed on Jul. 10, 2013.
(60) Provisional application No. 61/670,502, filed on Jul. 11, 2012.

(51) Int. Cl. G06Q 30/02; H04L 29/08; G06Q 20/20

(52) U.S. Cl. CPC G06Q 30/0268; G06Q 30/0255; G06Q 20/202; G06Q 20/209; H04L 67/12

(57) ABSTRACT

Disclosed are methods, systems, apparatus, devices, products and other implementations, including a method that includes intercepting, by a monitoring system, communications in a closed system between one or more peripheral devices and one or more host devices, the closed system being configured to enable communication between only designated closed system devices, the designated closed system devices including the one or more peripheral devices and the one or more host devices, with the communications including information relating to one or more transactions. The method further includes generating, by the monitoring system, based on at least one of the intercepted communications, supplemental data relating to at least one transaction of the one or more transactions, and communicating from the monitoring system to at least one of the designated closed system devices the supplemental data relating to the at least one transaction.

### CROSS-REFERENCE TO RELATED APPLICATIONS

This application claims the benefit of, and priority to, provisional U.S. application Ser. No. 61/670,502, entitled “GENERATION OF SUPPLEMENTAL DATA TO OUTPUT DATA PRODUCED BY CLOSED SYSTEMS,” and filed Jul. 11, 2012, and is a continuation of U.S. patent application Ser. No. 13/938,489, entitled “INTERCEPTION OF COMMUNICATIONS AND GENERATION OF SUPPLEMENTAL DATA IN CLOSED SYSTEMS,” filed Jul. 10, 2013 the content of both are incorporated herein by reference in their entireties.

### BACKGROUND

Closed systems are systems or networks that handle sensitive information (personal and/or credit information) and are generally configured to communicate with and/or process data from only specific devices/systems. Modifying functionality of a closed system, for example, adding another device with which the closed system may communicate, may be difficult, and sometimes may not be possible to implement.

### SUMMARY

In some variations, a method is disclosed. The method includes intercepting, by a monitoring system, communications in a closed system between one or more peripheral devices and one or more host devices, the closed system being configured to enable communication between only designated closed system devices, the designated closed system devices including the one or more peripheral devices and the one or more host devices, with the communications including information relating to one or more transactions.

The method further includes generating, by the monitoring system, based on at least one of the intercepted communications, supplemental data relating to at least one transaction of the one or more transactions, and communicating from the monitoring system to at least one of the designated closed system devices the supplemental data relating to the at least one transaction.

Embodiments of the method may include at least some of the features described in the present disclosure, including one or more of the following features.

Generating the supplemental data relating to the at least one transaction may include generating the supplemental data relating to the at least one transaction in response to a determination that the at least one transaction has been completed.

The one or more host devices of the closed system may include one or more cash registers to process purchase transactions, with the one or more cash registers being configured to conform to payment card industry data security standard (PCI DSS).

The one or more peripheral devices may include a surveillance device configured to associate at least some of the information relating to the one or more transactions with one or more respective images. The one or more respective images may include images of at least one of, for example, at least one of the one or more host devices, consumers, and/or cash register operators.

The one or more peripheral devices may include one or more cash register printers to print at least some of the information relating to the one or more transactions.

Communicating the supplemental data relating to the at least one transaction may include communicating to at least one of the one or more cash register printers coupon information relating to the at least one transaction in response to a determination that the at least one transaction has been completed, the coupon information being printed on a receipt for the at least one completed transaction printed by the at least one of the one or more cash register printers.

The coupon information may be generated based on the at least one of the intercepted communications relating to the at least one transaction.

The method may further include determining based on the at least one of the intercepted communications whether to communicate the supplemental data to the at least one of the designated closed system devices.

Communicating the supplemental data relating to the at least one transaction may include communicating to at least one of the one or more peripheral devices coupon information determined based, at least in part, on input received from a user. The determined coupon information may include one or more coupons selected by the user from a plurality of candidate coupons presented to the user.

Intercepting the communications in the closed system may include receiving the closed system communications at an interfacing unit of the monitoring system, communicating a copy of the at least one of the communications received at the interfacing unit to a server of the monitoring system, and communicating another copy of the at least one of the communications received at the interfacing unit to one or more of the designated closed system devices.

The interfacing unit may include a first microcontroller and a second microcontroller implementing universal serial bus (USB) connectivity between the interfacing unit, at least one of the one or more host devices, and at least one of the one or more peripheral devices.

The one or more peripheral devices may include at least one barcode scanner configured to facilitate determination of an item selected for processing in the at least one transaction.

Communicating the supplemental data relating to the at least one transaction may include communicating to at least one of the host devices the supplemental data, the supplemental data generated based at least in part on the item selected for processing in the at least one transaction, where the supplemental data may include one or more of, for example, information relating to the item selected for processing, and/or promotional information generated in response to the item selected for processing.

Generating the supplemental data relating to the at least one transaction may include determining at least one second item to be presented to a customer based on information, included in the intercepted communication, about at least one first item selected by the customer from a plurality of purchasable items, and based on effective measures that are each associated with at least one combination from a set of combinations that each includes the at least one first item to be purchased and a corresponding offer of cross-sale of at least one other item from the plurality of purchasable items, each of the effectiveness measures being representative of a likelihood that the at least one other item to be offered to the customer would be accepted when offered in combination with the at least one first item being purchased and computed based on p=s/N, where p represents the likelihood of the cross sale of the respective at least one other item when offered in combination with the respective at least one item from the plurality of purchasable items, s represents a number of successful cross sales over a period of time for the respective at least one other item when offered in combination with the respective at least item from the plurality of purchasable items, and N is the number of times a cross-sale promotion offering the respective at least one other item in combination with the respective at least one item from the plurality of purchasable items has been presented to the customer over the period of time.

Communicating the supplemental data may include communicating promotional information to the customer about a cross-sale offer to purchase the determined at least one second item. The promotional information may be communicated to one or more of, for example, a host device from the one or more host devices that includes a display to present the promotional information, and/or a printer from the one or more peripheral device to print at least the communicated promotional information on a print medium provided to the customer.

In some variations, a system IS disclosed. The system includes one or more processor-based devices, and one or more memory storage devices to store instructions that when executed on the one or more processor-based devices cause operations including intercepting communications in a closed system between one or more peripheral devices and one or more host devices, the closed system being configured to enable communication between only designated closed system devices, the designated closed system devices including the one or more peripheral devices and the one or more host devices, with the communications including information relating to one or more transactions. The instructions further cause operation including generating, based on at least one of the intercepted communications, supplemental data relating to at least one transaction of the one or more transactions, and communicating to at least one of the designated closed system devices the supplemental data relating to the at least one transaction.

Embodiments of the system may include at least some of the features described in the present disclosure, including at least some of the features described above in relation to the method.

In some variations, a non-transitory computer readable media programmed with a set of instructions executable on a processor is provided. The instructions, when executed, cause operations that include intercepting, by a monitoring system, communications in a closed system between one or more peripheral devices and one or more host devices, the closed system being configured to enable communication between only designated closed system devices, the designated closed system devices including the one or more peripheral devices and the one or more host devices, with the communications including information relating to one or more transactions. The instructions, when executed, further cause operations including generating, by the monitoring system, based on at least one of the intercepted communications, supplemental data relating to at least one transaction of the one or more transactions, and communicating from the monitoring system to at least one of the designated closed system devices the supplemental data relating to the at least one transaction.

Embodiments of the computer readable media may include at least some of the features described in the present disclosure, including at least some of the features described above in relation to the method and the system.

In some variations, an interfacing unit is provided. The interfacing unit includes one or more processor-based devices, and memory storage devices to store instructions that when executed on the one or more processor-based devices cause operations including receiving communications between one or more peripheral devices and one or more host devices in a closed system, the closed system being configured to enable communication between only designated closed system devices, the designated closed system devices including the one or more peripheral devices and the one or more host devices, with the communications including information relating to one or more transactions. The instructions, when executed, further cause operations including communicating a copy of at least one of the received communications to a server configured to generate, based on at least one of the received communications, supplemental data relating to at least one transaction of the one or more transactions and to forward to at least one of the designated closed system devices the generated supplemental data relating to the at least one transaction, and communicating another copy of the at least one of the received communications to the at least one of the designated closed system devices.

Embodiments of the device may include at least some of the features described in the present disclosure, including at least some of the features described above in relation to the method, the system, and the computer readable media, as well as the following feature.

The instructions may include instructions to cause further operations including receiving from the server the generated supplemental data, and communicating the generated supplemental data received at the interfacing unit to the at least one of the designated closed system devices.

Unless defined otherwise, all technical and scientific terms used herein have the same meaning as commonly or conventionally understood. As used herein, the articles “a” and “an” refer to one or to more than one (i.e., to at least one) of the grammatical object of the article. By way of example, “an element” means one element or more than one element. “About” and/or “approximately” as used herein when referring to a measurable value such as an amount, a temporal duration, and the like, encompasses variations of ±20% or ±10%, ±5%, or +0.1% from the specified value, as such variations are appropriate to in the context of the systems, devices, circuits, methods, and other implementations described herein. “Substantially” as used herein when referring to a measurable value such as an amount, a temporal duration, a physical attribute (such as frequency), and the like, also encompasses variations of ±20% or ±10%, ±5%, or +0.1% from the specified value, as such variations are appropriate to in the context of the systems, devices, circuits, methods, and other implementations described herein.

As used herein, including in the claims, “or” or “and” as used in a list of items prefaced by “at least one of” or “one or more of’ indicates that any combination of the listed items may be used. For example, a list of “at least one of A, B, or C” includes any of the combinations A or B or C or AB or AC or BC and/or ABC (i.e., A and B and C). Furthermore, to the extent more than one occurrence or use of the items A, B, or C is possible, multiple uses of A, B, and/or C may form part of the contemplated combinations. For example, a list of “at least one of A, B, or C” (or “one or more of A, B, or C”) may also include A, AA, AAB, AAA, BB, BCC, etc.

As used herein, including in the claims, unless otherwise stated, a statement that a function, operation, or feature, is “based on” an item and/or condition means that the function, operation, function is based on the stated item and/or condition and may be based on one or more items and/or conditions in addition to the stated item and/or condition.

Details of one or more implementations are set forth in the accompanying drawings and in the description below. Further features, aspects, and advantages will become apparent from the description, the drawings, and the claims.

### BRIEF DESCRIPTION OF THE DRAWINGS

FIG. 1 is a schematic diagram of an example implementation in which closed-system communications can be intercepted and supplemental data generated.

FIG. 2 is a schematic diagram of another example implementation in which closed system communications can be intercepted and supplemental data generated.

FIG. 3 is a flowchart of an example procedure to intercept communications and to generate supplemental data.

FIG. 4 is a schematic diagram of a generic computing system.

Like reference symbols in the various drawings indicate like elements.

### DETAILED DESCRIPTION

Disclosed herein are methods, systems, apparatus, devices, computer program products, and other implementations, including a method that includes intercepting, by a monitoring system, communications in a closed system between one or more peripheral devices (e.g., printers, security cameras, barcode scanners, other types of input/output devices, etc.), and one or more host devices (e.g., cash registers and/or other types of point-of-sale (POS) devices). The closed system (which may conform to the payment card industry data security standard, or PCI DSS) is configured to enable communication between only designated closed system devices, such as the one or more peripheral devices and the one or more host devices. The intercepted communications include information relating to one or more transactions. The method further includes generating, by the monitoring system, based on at least one of the intercepted communications, supplemental data relating to at least one transaction of the one or more transactions (e.g., promotional data such as coupon data, additional particulars about the at least one transaction and/or the transaction's constituents, etc.), and communicating from the monitoring system to at least one of the designated closed system devices the supplemental data relating to the at least one transaction.

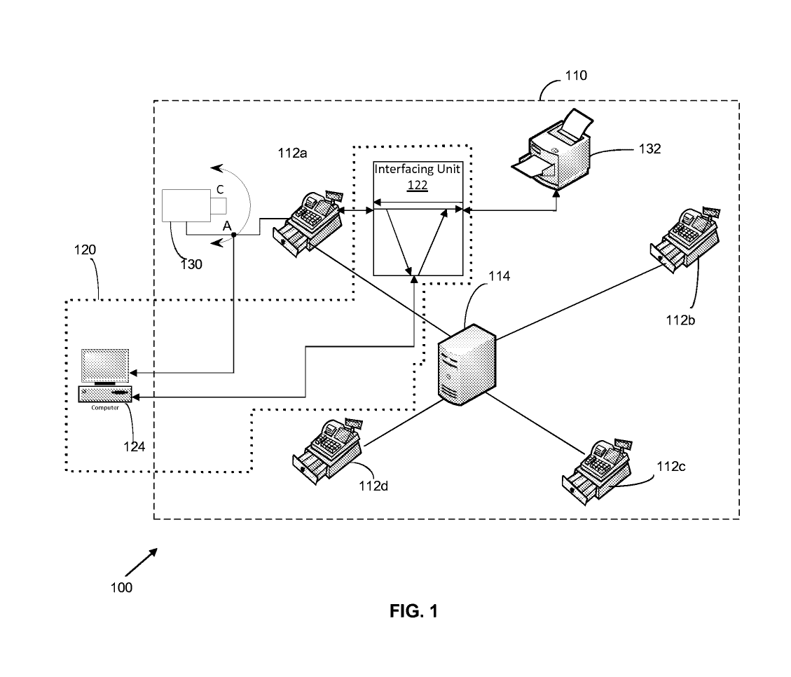

Thus, with reference to FIG. 1, a schematic diagram of an example system implementation 100 in which closed system communications are intercepted and monitored, and in which supplemental data is generated, is shown. The system 100 includes a closed system 110 which is configured to enable communication between, and/or process data from, only designated closed system devices, such as specific peripheral devices and/or specific host devices, thus limiting the closed system's connectivity to other systems. An example of a closed system is a system or network handling sensitive information, for example, a system that includes one or more host devices such as point-of-sale (POS) devices 112a-d that are depicted as cash registers in FIG. 1 (other types of POS devices, or other types of host device, may also be used), and which may be, in some embodiments, configured to conform to payment card industry data security standard (PCI DSS). A system conforming to PCI DSS generally has to meet certain system configuration/implementation requirements, such as, for example, installing and maintaining a firewall to protect cardholder data of customers entering into various transactions (retail or service transactions) via the closed system, protect card holders' data, encrypt transmission across public/non-private networks, etc.

The closed system 110 may also include, in some embodiments, a central server 114 in communication with the other devices/nodes constituting the closed system 110, and may be configured to receive data from any of the nodes/devices of the closed system to centrally process data. A closed system, such as the closed system 110 will generally not receive or transmit data to non-authorized sources that have not been earlier designated as legitimate sources from which to receive data or to transmit to data. In some embodiments, other point-of-sale (POS) devices may be used in place of, or in addition to, the POS devices 112a-d. Additional examples of point-of-sale (POS) devices/stations are described in U.S. patent application Ser. No. 11/314,713, entitled “SYSTEMS AND METHODS FOR AUTOMATIC CONTROL OF MARKETING ACTIONS,” and U.S. patent application Ser. No. 11/611,481, entitled “EXPOSURE-BASED SCHEDULING,” the contents of both of which are hereby incorporated by reference in their entireties.

In order for a non-designated system/device to receive and process data from the closed system, communications sent to or from the closed system (e.g., from one of its nodes), the system 100 includes a monitoring system 120 comprising a server 124 coupled to an interfacing unit 122 (both of which may be processor-based devices) that together are configured to intercept communications (e.g., communications relating to one or more transactions, such as retail or service transactions) communicated in the closed system between the closed system devices. The interfacing unit 122 is configured, in some embodiments, to implement serial connectivity between at least one of the host devices, the monitoring system and at least one peripheral device, be it an input peripheral device, such as a barcode scanner (not shown in FIG. 1) or an output peripheral device, such as a printer. In the example of FIG. 1, the POS device 1I2a is illustrated as being connected to, and allowed to send data to, a surveillance camera 130 and/or a printer 132. For ease of illustration, only one POS device is illustrated as being coupled to the peripheral devices 130 and/or 132, although anyone of the nodes constituting the closed system 110 may be coupled to same or different peripheral devices. Communications sent from the POS device to the printer 132 may thus be routed through the interfacing unit 122 (such a unit may be configured to be part of the closed system implementation, but still able to transmit/receive communications to and from devices not otherwise forming part of the closed system), whereupon the communication may be split so that a copy of the communication is directed to the server 124, while another copy is directed to the printer 132. Alternatively, in some embodiments, the monitoring system 120 may intercept the communication sent, for example, from the POS device 1I2a to the printer 132 (and also from the camera 130) by tapping the communication links between the POS device 1I2a and the camera 130 or the printer 132 (such links may be wired or wireless). By intercepting communications, the closed system 110 does not need to be modified (which may not be possible), or to be initially implemented to allow communication with the monitoring system. The monitoring system 120 could be configured to intercept, and otherwise operate with, any type of closed system. The interfacing unit 122 of the monitoring system 120 is typically (although does not necessarily have to be) situated proximate to the where the devices constituting the closed system, and thus may be situated on the premises of C-stores employing a closed system, quick-service restaurants employing a closed system, grocery stores employing a closed system, etc.

The monitoring system is additionally configured to generate and communicate, based on at least one of the communications received by an interfacing unit (such as the interfacing unit 122), supplemental data relating to at least one transaction of the one or more transaction corresponding to intercepted communications. Such supplemental data may include promotional data (e.g., coupons, information about contests a customer can participate in, etc.), particulars regarding items constituting the at least one transaction (e.g., serial number, description information, prices, etc.), and so on. The generated supplemental data is communicated from the monitoring system to at least one of the designated closed system devices via the interfacing unit. For example, consider a situation where a host device communicates a communication that includes information regarding a particular transaction and an indication that the transaction has been completed. In some embodiments, the indication that the transaction has been completed may include a completion code sent by the host device, confirmation of a credit card charge etc. In some embodiments, the host device may only send communications with information about transactions once the respective transactions have been finalized, in which case the monitoring system intercepting the communication may determine that a transaction has been completed based on the fact that it has received a communication corresponding to the transaction. Continuing with the example, in response to receiving data relating to the intercepted communication (and, in some embodiments, in response to a determination that the at least one transaction corresponding to the communication has been completed), the monitoring system generates the supplemental data (e.g., by the server 124). As noted, the supplemental data can include promotional data (coupons, cross-sale offers), additional data about items constituting the just completed transaction, etc. The generated supplemental data can then be communicated by the server 124 back to the interfacing unit 122, and from there to, for example, the printer 132 where the generated supplemental data may be printed along with at least some of the data included in the intercepted communication (promotional data generated based on the data of the intercepted communication is generally printed immediately below transaction details obtained from the data included in the communication that originated from the host device). In some embodiments, the interfacing unit may have immediately forwarded a copy of the communication it received to the printer, and the generated supplemental data is subsequently provided to the printer 132 at a later point. In some embodiments, the interfacing unit may temporarily store the data from the intercepted communication and subsequently combine it with the supplemental data before sending the combined data to the designated peripheral device. In some embodiments, the interfacing unit 122 may also be configured to determine whether to override supplemental data received from the monitoring system, or queue the information and forward it to the printer 132 to be printed out. The printer receiving the supplemental data from the interfacing unit can print the supplemental data generated by the monitoring system 120 without any violation of PCI requirement occurring, and/or without having to incorporate the monitoring system 120 to the definitions and landscape of the closed system 110.

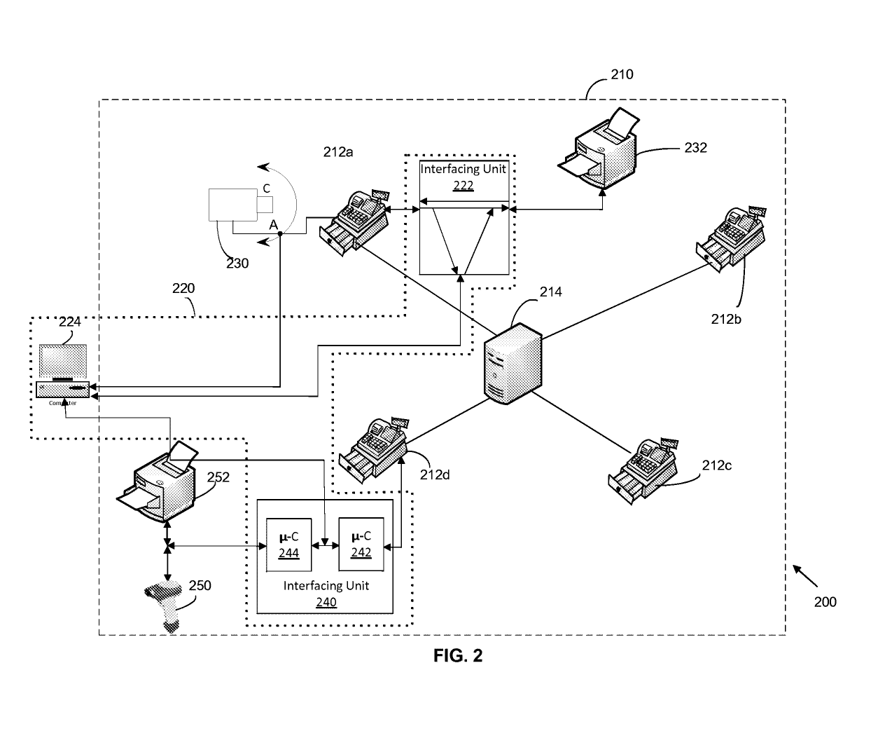

In some implementations, generated supplemental data may be forwarded to a host device. For example, consider a situation where an input peripheral device, such as a barcode scanner (similar to the barcode scanner 250 illustrated in FIG. 2), obtains information relating to a transaction (for example, the barcode scanner determines identifying information regarding an item whose barcode it scanned), and transmits a communication in the direction of the host device(s) to which it is coupled. The communication is intercepted by the monitoring system 120 at the interfacing unit 122, and the data of the communication is provided to the server 124. In response to the received data, the monitoring system 120 generates supplemental data (e.g., by the server 124) based, at least in part, on the information relating to the transaction (e.g., information regarding the item identified through the scanning operation performed by the barcode scanner). Here too, the generated supplemental data may include promotional data, additional particulars pertaining to the transaction corresponding to the intercepted communication, etc. The generated supplemental data is communicated back to the interfacing unit 122, and is directed to the host device (e.g., the POS device 112a in the example of FIG. 1). In some implementations, supplemental data may be generated in response to data in a communication received from a host device, and the generated supplemental data may then be directed (via to the interfacing unit) back to the host device. This may happen, for example, when determining potential cross-sale offers that are to be presented to a customer before a transaction is completed.

In some embodiments, the promotional information (e.g., coupon information, cross sale offers, rewards provided to the customer in response to achieving a chance-based outcome for an activity performable by the customer, or other types of promotional data) may be generated (and sent to the appropriate closed-system designated device) based on the intercepted communication(s). Thus, in such embodiments, the promotional information to be sent to a particular closed system device(s) may be optimal or near optimal in terms of the provisional data being customized to the particular purchaser (consumer) who is engaged in a transaction taking place at the closed system. Implementations of generating coupon and other promotional information based on data of intercepted communication may be similar to the implementations described in U.S. Pat. No. 8,321,276 (application serial No. 12/697,867), entitled “PROCESSING OF COMMERCE-BASED ACTIVITIES”, and filed Feb. 1, 2010, the content of which is hereby incorporated by reference in its entirety, in which appropriate cross-sale offers were generated and presented to a consumer.

Briefly, in some implementations, data of intercepted communications from one of the nodes of a closed system may be used, for example, to identify relevant combinations of first items corresponding to a consumer selection (e.g., the item(s) of a transaction), and associated second one or more items, or to identify/determine some other offer (e.g., a discount) that may be offered to the consumer as coupon. One or more such combinations are then selected, and data corresponding to that selected/determined one or more combinations is communicated to the appropriate closed system device. Such data may include particulars regarding the one or more items to be offered at a discount for a future purchase or an immediate purchase (i.e., as a cross-sale), including a description of the one or more items being offered (if specific items are being offered), their prices, visuals of the items (e.g., a picture), applicable discounts or specials to be offered, etc.

In some embodiments, the offers (or other types of supplemental data) offered to a consumer may be identified from a set of combinations that includes records, or entries, of combinations of one or more first items (i.e., items that were initially chosen by the consumer) and corresponding one or more second items, e.g., tangible items, services, a general monetary discount or offer, etc. Each combination (stored in a central repository that may be part of a server such as the server 124 of the monitoring system 120) may be associated with an effectiveness measure that represents the probability that the consumer would accept the one or more second items of that combination given that the consumer already purchased (or has agreed to purchase) the associated one or more first items. In some embodiments, the combination may also be associated with other data, such as a confidence interval representative of the uncertainly associated with effectiveness measures. Thus, an intercepted communication(s) that includes information identifying one or more first items (e.g., food items) purchased by the consumer is then used to access a repository of combinations to determine a sub-group with those combinations that include the particular one or more first items. In some embodiments, the combination associated with the highest effective measure from the combination in the determined sub-group is selected, and information based on that combination, including the identity of one or more second items (be it specific items, a general discount, or some other offer) are sent to the appropriate closed system device of the closed system 110. In some embodiments, several combinations may be selected (e.g., 3-5 combinations having the highest respective effectiveness measures), and a scheme incorporating a randomness element may be used to select one of those combinations so that more than one combination (corresponding to promotions) may have an opportunity to be presented to consumers.

As noted, in some implementations, each item, or combination of items, is associated with an effectiveness measure, representative of the likelihood, p, that a cross-sale offer of the item(s) will be accepted, and an associated confidence interval. In some embodiments, computations of adjusted effectiveness measure is performed by first increasing the old confidence interval value by some pre-determined confidence value (for example, 0.005 Period (e.g., in days) since the last updating of the confidence interval for the particular item(s)). Although the description provided herein pertains to determining cross-sale combinations using effective measures computations, the procedure may also be applied for the purpose of determining other types of promotions using effective measures computations.

Generally, the effectiveness measure and confidence interval associated with a particular item may be computed, in some embodiments, based on the expressions:

P=s/N,

where p is the likelihood of a successful cross-sale offer, s represents the success score (the number of successful cross-sales) and N is the number of times a cross-sale promotion offering the particular item has been presented to a customer. The values p, s and N may be computed based on certain factors that are taken into account (e.g., s may be computed based on certain rules that define under what circumstances an outcome is to be deemed a success, and s may then be reduced by a success factor). The confidence interval, CI, may be computed according to the expression:

$$CI = z * \sqrt{\frac{p * ( 1 - p )}{n}}$$

where z represents the number of standard deviations to achieve a required significance (under the assumption of normal distribution). The z factor represents the probability that an actual value will be within the CI. The higher the z factor, the higher that probability is. The required significance, under those circumstances, is computed as (1−z), i.e., the probability it is outside the CI. So if z=1, there is a 69% certainty that the value is within CI. A value of z=1 may be used because the purpose of the confidence interval is to be a comparative measure for different estimate values, thus multiplying it by any constant is generally not required. It is to be noted that z=1 corresponds to statistical significance of about 31%, z=2 corresponds to 5%, and z=3 corresponds to 1%.

To compute the updated effectiveness measure and confidence interval for a particular item (or a combination of items), an adjusted value of N is determined using the relationship:

N_{old}=p_{old}*(1−p_{old})/confidence_{old}²

The updated effectiveness measure may thus be computed according to:

p_{updated}=(p_{old}*N_{old}+p_{measured}*Nₚ)/(N_{old}+Nₚ)

where p_{measured} corresponds to the effectiveness measure computed for the current interval alone (i.e., without factoring in the old effectiveness measure and/or the old confidence interval). Under circumstances where the particular item was not presented in any promotion in the most recent interval, the updated effectiveness measure is simply computed to be p_{old}.

The updated value for the confidence interval may be computed according to the expression:

$${CI}_{updated} = √ \frac{p * ( 1 - p )}{{N}_{old} + {N}_{p}}$$

where Np is the number of promotions in which the particular item has been offered in the current period (i.e., since the last time that the effectiveness measure and confidence interval for that particular item have been computed).

It should be noted that the initial values for the effectiveness measures and confidence intervals for any item, or combination of items, presented as a cross-sale offer to a customer in response to a selection by the customer of one or more items may be set, for example, to an effectiveness measure of 0 with a confidence interval of 1. Other initial values may be used.

To illustrate the procedure to update selection parameters (e.g., effectiveness measure, confidence interval, etc.) for a particular item (or a combination of items to be promoted), consider an example in which a particular item A is associated with an effectiveness measure of, for example, 2.5% that was previously computed based on a success score of 5 (e.g., five successful promotions) resulting from 200 cross-sale promotions involving the item A (item A may, in fact, correspond to a combination of several items that are offered as a package deal). The current confidence interval for the item A is computed as CI_{A}=√0.025*(1−0.025)/200=0.011. These parameters are subsequently used in the selection process to determine cross-sale offers to a customer in response to the customer's initial selection of one or more items.

When these parameters are to be updated (e.g., at the end of some pre-determined period), the sum of successful offers resulting from N number of promotions following the most recent update (which resulted in the current effectiveness measure 0.025 and a confidence interval of 0.011) will be used to compute the updated parameters. Suppose that in the above example, over the subsequent pre-determined period (e.g., a week) the item A was cross-sale offered 250 times, and those offers resulted in 10 successful offer acceptances. Thus, during the current period, Nₚ is 250 and the new effectiveness measure, p_{measured}, is 10/250=0.04.

Suppose also that the old confidence interval associated with the item A was modified daily to reflect the increasing uncertainty of the validity of the aging parameters, and that by week's end the old confidence interval for the item A was modified from its initial 0.011 value to 0.012 (in some embodiments, this modification may occur at set intervals based on some pre-determined function). Accordingly, to update the old parameter values of the effectiveness measure and the confidence interval, an adjusted value N that corresponds to the effectiveness measure of 0.025 and the modified confidence interval of 0.012 is computed according to:

N=p(1−p)CI²

where p is the effectiveness measure representative of the likelihood that a customer would accept a cross-sale offer of A in response to the customer's initial order. Plugging in the values of p=0.025 and CI=0.012, the corresponding adjusted value of N is computed to be approximately 169 samples.

With that computed adjusted value of N corresponding to the periodically modified old confidence interval value, the updated effectiveness measure and updated confidence interval are computed according to the Equations:

$${p}_{updated} = ( {p}_{old} * {N}_{old} + {p}_{measured} * {N}_{p} ) / ( {N}_{old} + {N}_{p} )$$

$$and {CI}_{updated} = √ \frac{p * ( 1 - p )}{{N}_{old} + {N}_{p}}$$

to yield the values of p_{updated}−0.034, and CI_{updated}=sqrt(0.034*(1−0.034)/(169+2S0)=0.0088.

In the above computation factors, such as the randomness success factor (RSF), were not taken into account. However, in some implementation, the RSF, as well as other factors, may be taken into account to compute the selection parameters such as the effectiveness measure and/or the confidence interval.

In some embodiments, determination of the at least one item to be included in the promotional information to be offered to a consumer may be performed using a machine learning system (which may be implemented on the server 124 of the monitoring system 120). In some implementations, a machine learning system may be configured to iteratively analyze training input data and the input data's corresponding output, and derive functions or models that cause subsequent inputs of first items purchased by a consumer to produce outputs consistent with the machine's learned behavior. In some embodiments, the learning machine system may be implemented based on a neural network system. A neural network includes interconnected processing elements (effectively the systems neurons). The connections between processing elements in the neural network have weights that cause output from one processing element to be weighed before being provided as input to the next interconnected processing elements. The weight values between connections can be varied, thereby enabling the neural network to adapt (or learn) in response to training data it receives. In some embodiments, the learning machine may be implemented as a support vector machine configured to generate, for example, classification functions or general regression function. In some embodiments, the machine learning system may be implemented using decision trees techniques, regression techniques to derive best-fit curves, and/or other types of machine learning techniques.

In some embodiments, the supplemental data communicated to a designated closed system device may be based on input from the user. For example, the user may be provided with several coupons from which he/she may select one or more desired coupons. The selected coupons are then sent (e.g., by the monitoring system) to the appropriate output device(s). The candidate coupons presented to the user (e.g., on a display device positioned near the user) may have been determined based on the intercepted communication(s) (e.g., based on a procedure such as the one described above for selecting items, or coupons, with relatively high effectiveness measures).

With continued reference to FIG. 1, in some variations one or more of the peripheral devices may include a surveillance system, which may include the camera 130 and/or a recorder or storage space (e.g., a DVR, not shown) on which to store captured images. The surveillance system may be configured to associate at least some of the information relating to one or more transactions with one or more respective images. For example, the surveillance system can associate details of a particular transaction with images of the consumer consummating the transaction, the node at which that particular transaction is taking place (e.g., the particular cash register), an operator at the node, the items which are the subject of the particular transaction, etc. The information of the transaction may be recorded/embedded in visual form into the image(s) that is being captured (e.g., the information may be superimposed on the respective image, or the information may be recorded separately from the respective image). Associating transactions details with respective images of the transactions may be used, for example, to implement loss prevention and/or employee monitoring programs, to counter such criminal activities as theft, embezzlement, fraud, etc. The one or more peripheral devices may also include, as noted, a printer on which various transaction details may be recorded. In some embodiments, communication sent to the surveillance system may be directed (e.g., uni-directionally) to the monitoring system 120, which may also use information included in communications sent to the surveillance system of the closed system 110 to determine, for example, whether any of the transactions associated with intercepted communications have been completed.

With reference now to FIG. 2, a schematic diagram of another example system implementation 200 in which communications in a closed system can be intercepted, and supplemental data generated, is shown. The example system 200 includes some of the configuration and functionality of the example system 100. For example, the system 200 includes a plurality of POS devices such as cash registers, namely, the cash registers 212a-d, which may be similar to any of the cash registers 112a-d depicted in FIG. 1, that are arranged in a closed-system configuration (marked as closed system 210), and may be adapted to conform to payment card industry data security standard (PCI DSS). The closed system 210 may also include a central server 214, which may be similar its implementation and/or functionality to the server 114, that is in communication with at least some of the devices/nodes constituting the closed system 110 (e.g., the host devices of the closed system, such as the devices 212a-d), and may be configured to receive data from any of those nodes/devices of the closed system to centrally process data. In some embodiments, other point-of-sale (POS) devices (e.g., devices such as those described in U.S. application Ser. No. 11/314,713) may also be used.

The system 200 further includes a monitoring system 220, which may be similar to the system 120 in its implementation and functionality, that includes a server 224 coupled to an interfacing unit 222 (which, in some embodiments, may be similar to the interfacing unit 122), which together are configured to intercept communications between various authorized designated devices of the closed system. Thus, communications sent from a cash register to the printer 232 may be routed through the interfacing unit 122, at which point the communication may be split so that a copy of the communication is directed to the server 224 (e.g., which may be implemented as a local host at the store-level of the monitoring system 220), while another copy is directed to the printer 232.

As further illustrated in FIG. 2, in some embodiments, the system 200 may further include an USB-implemented interfacing unit 240, which in conjunction with the server 224 to which it is coupled, is configured to intercept communications to and from one or more POS devices (in the example of FIG. 2, the interface 240 is coupled to the cash register 212d), route copies of the communications to the server 224, and forward another copy (which may be the original) to one or more of the peripheral devices or the POS devices coupled to the interfacing unit 240. In the example system 200, two peripheral devices are shown to be coupled to the interfacing unit 240, namely, a barcode scanner 250 and a printer 252 (which may be similar to the printer 232 or to the printer 132 of FIG. 1). Other types of peripheral devices may also be coupled to the interfacing unit 240, and thus be interconnected to the cash register 212d (or some other POS device).

In some embodiments, the USB-based interfacing unit 240, implementing USB-type connectivity between the interconnected cash register 212d, the monitoring system 220, and the peripheral devices 250 and 252, may be realized with controllers (e.g., processor-based microcontrollers). For example, the interfacing unit 240 may be implemented using a first microcontroller 242 that is in direct communication with the cash register 212d, and a second microcontroller 244 that is in direct communication with the first microcontroller 242 and with the peripheral devices 250 and 252. In some embodiments, the microcontrollers 242 and 244 may be commercially available microcontrollers (e.g. Microchip's PIC series, Xilinx Spartan 6), although custom-made microcontrollers may also be developed and realized. Each of the microcontrollers 242 and 244 may implement a USB protocol, and may thus be configured to react/respond to communications received at its ports, implement a USB state machine, track the microcontroller's status, manage its communication, etc.

In embodiments in which microcontrollers are used (e.g., a traditional microcontroller (PIC) or a FPGA such as the Spartan microcontroller referred to above) to implement/program the required logic, the microcontrollers typically include a dedicated, embedded program to enable realizing the functionality of the micro controller, but generally do not include an operating system. Such micro controller implementation can thus avoid many vulnerabilities that richer-feature OS-based systems (e.g., a System-on-Chip circuit that runs an operation system such as Linux). Because many microcontrollers are used with USB connected peripherals devices, such microcontrollers may include a USB controller, and may have native functionality, such as the ability for serial communication. In some embodiments, the microcontrollers may include convenient-to-use libraries (e.g., PIC may come with USB libraries and COM over USB). Microcontrollers may include non-volatile memory to contain the application, and then programmed in-circuit. In some embodiments, the program for use with the microcontroller may be developed on a separate computing platform, and tested either on a simulator or on a development board, e.g., a board may include a programmer chip that feeds the program into the micro controller, the microcontroller itself, and a debugger chip that enables running the program on the microcontroller line-by-line. The program can either be in assembly language, but more commonly in a higher language that is then compiled into machine code. In FPDAs the configuration of the device itself is modified “in the field” (i.e., after manufacturing), so the device can be adapted to its exact function. Commonly, FPGAs are used to solve simpler problems than those microcontrollers solve, but they result in much simpler circuits.

In some embodiments, the first micro controller 242 (which is in direct communication with the cash register, or some other POS device) is configured to implement the USB protocol as a peripheral device. Thus, the POS device views the interfacing unit as if it were a peripheral device (similar to other peripherals devices, such as a printer, a barcode scanner, etc.) that can be connected and communicated with the POS device in a closed system configuration. When data arrives at the first microcontroller 242 from the POS, the microcontroller 242 is configured to forward that data to the other microcontroller, e.g., the second microcontroller 244 of the example interfacing unit 244, which in turn is configured to forward the data it receives from the first microcontroller to the peripheral device(s) coupled to the interfacing unit 240. The microcontroller 242 is also configured to forward a copy of the data received from the POS to the server 224 of the monitoring system 220. As noted, the system 220 is configured to use the data sent from the POS device to generate supplemental data (e.g., promotional data such as cross-sale offers to be presented to the customer, coupons rewards to be provided to the customer in response to achieving a chance based outcome for an activity performable by the customer, etc.) based on the data provided by the POS device (e.g., data representative of a completed transaction). The supplemental data (which may be generated by the server 224) is then sent back to the interfacing unit 240, whereupon it may be combined (in circumstances where the interfacing unit delayed the transmission of the data sent by the POS device to the destination closed system device), and sent, via the second microcontroller 244, to an output peripheral device. In some embodiments, the data sent by the POS device may have been forwarded to the output peripheral device without being delayed until the supplemental data responsive to the data provided by the POS device is generated and sent to the interfacing unit. The use of micro controllers, implementing a USB protocol, to realize the interfacing unit 240 enables considerable flexibility in configuring the functionality and particular sequence of operations that can performed in the course of supplementing primary data generated in a closed-system and providing the primary data and the supplemental data to the closed system devices. It is to be noted that, in some embodiments, the closed-system data intercepted, and or the supplemental data generated, are of non-sensitive nature, thus allaying concerns of using the implementations described herein for improper purposes.

When the first microcontroller 242 receives data from the second microcontroller 244, e.g., when an input peripheral device, such as the scanner 250, provides input data to be communicated to the POS device, the data may be provided to the first microcontroller 242, which in turn is configured (in response to receiving data from the second microcontroller device 244) to forward the received data to the POS device (i.e., to the cash register 212d in the example system 200). In some embodiments, the interfacing unit 240 may be configured to receive data from the server 224 of the monitoring system 220, where such data may include supplemental data (e.g., marketing or promotional-based data) responsive to data communicated to the interfacing unit 240 from a peripheral device (such as the barcode scanner 250 that provides input to the POS device). In this situation, the interfacing unit 240 is configured to forward the supplemental data to the POS device. For example, upon the peripheral barcode scanner device 250 scanning the barcode of a product (which may have been selected for purchase by a customer), or otherwise obtaining data representative of the identity of the product, the data representative of the identity of the product is forwarded to the second microcontroller 244 of the interfacing unit 240 which is then configured, in some embodiments, to direct the data (or, alternatively, resulting data processed by the second microcontroller 244) to the system 220. Based on the data representative of the identity of the product, supplemental data may also be generated and sent to the interfacing unit 240. The supplemental data can then be combined with the data communicated to the second microcontroller 244 from the input peripheral device (the barcode scanner 250 in this case). Because the first microcontroller 242 is configured to act as a peripheral device from the perspective of the POS device to which the first microcontroller is coupled, data sent by the system 220 and/or the input peripheral device to the POS device via the interfacing unit 240 will be treated, by the POS device, as having been sent by a peripheral device (e.g., in this situation, the microcontroller is emulating input-sending functionality of a peripheral device).

In effect, the interfacing unit can be thought off as “fooling” the POS to conclude that it is receiving data from a legitimate input peripheral device (such as a barcode scanner) in which case the POS determines that it is received a scanned barcode input.

The second microcontroller that is directly coupled to the peripheral device, namely, the microcontroller 244 in the example system 200 of FIG. 2, may be configured, in some embodiments, to serve as a host device for the implementation of the USB protocol (e.g., pretending to be the POS as viewed by actual peripheral devices coupled to the interfacing unit 240). When data arrives from the other micro controller, namely, the first microcontroller 242 (e.g., transaction data to be printed as a receipt by the printer 252 in the example system 200 of FIG. 2), it forwards the data to the appropriate peripheral device (the peripheral device, viewing the microcontroller as a host, will accept host data, in conformity with any of the closed-system protocols). When data is communicated from the POS device, the first microcontroller 242, acting as a peripheral device (and thus capable of receiving data from the POS) is configured to forward the data to the second microcontroller and/or to the server 224.

On the other hand, the second microcontroller 244 forwards data received from an input peripheral device (such as the barcode scanner 250) to first microcontroller 242 (communication from the microcontroller 244 to the first microcontroller 242 is a host-to peripheral communication, and is thus permissible), and the first microcontroller 242 relays the data received from the second microcontroller 244 (or supplemental data received from the server 224 of the monitoring system 220) to the POS device. As noted, data communication from the microcontroller 242 to the POS device is a peripheral device-to host device (POS) communication, which is a permissible communication in the closed-system implementation of FIG. 2, as the POS device views communications received from the first microcontroller 242 as input communication received from an input peripheral device of the closed-system. The configurations described herein thus enable interjecting and adding messages and data to the closed-system communications, as well as to listen to two-way communications between of the various closed-system devices.

Thus, in the example embodiments of the system 200 depicted in FIG. 2, peripheral devices can communicate with a microcontroller of a two-microcontroller configuration of an interfacing unit (implementing USB connectivity) directly coupled to them because the peripheral devices view that microcontroller 244 as a host device, while the POS can communicate with the other microcontroller (the microcontroller 242 in the example of FIG. 2) of the interfacing unit because the POS device views the other microcontroller as a peripheral device.

In some embodiments of the host/peripheral configurations of the microcontrollers of the interfacing unit 240, the microcontrollers may each handle one side of a communication transaction (as a host or as a peripheral) independently, and relay received data at the first available opportunity (such implementations are also referred to as the “two short cycles” implementations). In implementations of such a communication scheme (which are generally fairly straightforward to implement) the microcontrollers may be able to use available USB libraries. On the other hand, the host/peripheral implementations require that the microcontrollers be configured to perform various exception handling situations (e.g., where one side is connected and the other side is not).

In some embodiments, the microcontrollers may be configured as substantially dumb devices/units which do not directly emulate the host or the peripheral, but rather are configured to forward each message coming from one microcontroller to the other. In this mode, also referred to as a “long cycle” implementation, all the microcontrollers do, other than message-forwarding operations, is determine where to interject with additional externally-initiated messages (e.g., the supplemental data described herein). In this mode, there may be some delay added to the message forwarding transactions/operations performed by the micro controllers. Additionally, this mode may not be entirely compatible with the USB protocol.

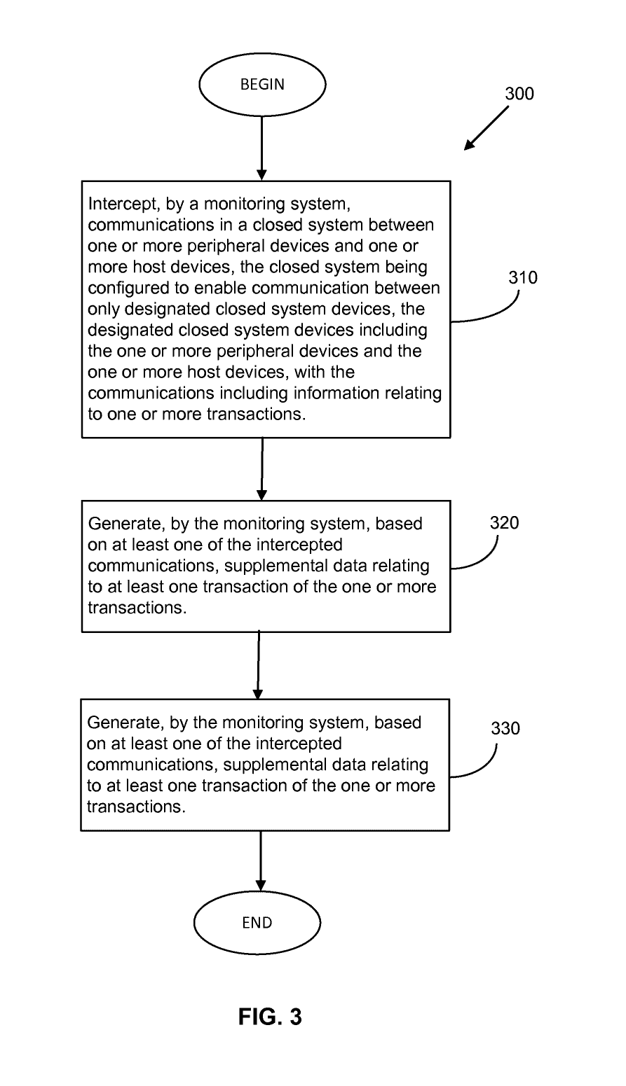

With reference now to FIG. 3, a flowchart of an example procedure 300 to generate supplemental data is shown. The procedure 300 includes intercepting 310 (for example, by a monitoring system comprising a server coupled to an interfacing unit) communications in a closed system between one or more peripheral devices and one or more host devices, where the closed system is configured to enable communication between only designated closed system devices. The designated closed system devices include the one or more peripheral devices (e.g., input peripheral devices, such as a barcode scanner, and output peripheral devices, such as a printer) and the one or more host devices (e.g., POS devices such as cash registers). The communications that are intercepted include information relating to one or more transactions (e.g., purchase transactions). The interception of the closed system communications may be performed using an interfacing unit such as the interfacing units 122 or 222 depicted in FIGS. 1 and 2 (the interfacing units 122 and 222 implement serial and/or parallel connectivity between the host devices and the peripheral devices, and/or the interfacing unit 240 depicted in FIG. 2 (the interfacing unit 240 implements USB-type connectivity between the host devices and the peripheral devices).

The monitoring system generates 320, based on at least one of the intercepted communications, supplemental data relating to at least one transaction of the one or more transactions. The supplemental data may include promotional data such as data pertaining to cross-sale offers, coupons data, data about contests a customer can participate in, etc., and may also include particulars regarding items constituting the at least one transaction (e.g., serial numbers of items, description information, prices, etc.). Other types of supplemental data responsive to the intercepted communication(s) may also be generated.

The generated supplemental data is communicated 330 from the monitoring system to at least one of the designated closed system devices. For example, when the supplemental data includes particulars about items scanned by a barcode scanner (i.e., the supplemental data is generated in response to data from an input peripheral device), the supplemental data is communicated from the monitoring system to a host device (e.g., via an interfacing unit). When the supplemental data includes, for example, promotional data (e.g., the supplemental data is generated in response to transaction details and/or end-of-transaction indication received from a host device such as a POS device depicted in FIGS. 1 and 2), the supplemental data is communicated, e.g., via an interfacing unit, to, for example, an output peripheral device (e.g., a printer such as the printers 132,232, and 252 shown in FIGS. 1 and 2). When communicated to an output peripheral device, the supplemental data may be printed (or otherwise recorded) with the communication that was intercepted by the monitoring system (e.g., supplemental data regarding various promotions may be printed below data pertaining to a just completed transaction).

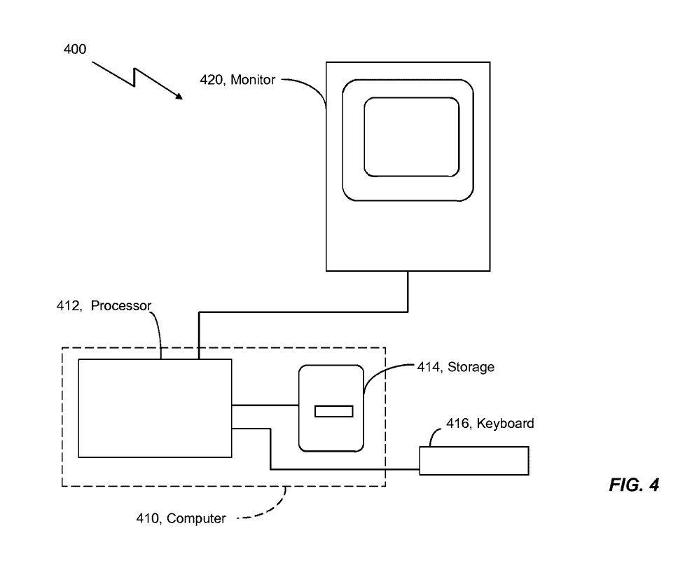

Performing the various operations described herein may be facilitated by a processor based computing system. Particularly, each of the various systems/devices described herein may be implemented using one or more processing-based devices. Thus, with reference to FIG. 4, a schematic diagram of a generic computing system 400 is shown. The computing system 400 includes a processor-based device 410 such as a personal computer, a specialized computing device, and so forth, that typically includes a central processor unit 412. In addition to the CPU 412, the system includes main memory, cache memory and bus interface circuits (not shown). The processor-based device 410 may include a mass storage element 414, such as a hard drive or flash drive associated with the computer system. The computing system 400 may further include a keyboard, or keypad, or some other user input interface 416, and a monitor 420, e.g., a CRT (cathode ray tube) or LCD (liquid crystal display) monitor, that may be placed where a user can access them.

The processor-based device 410 is configured to facilitate, for example, the implementation of operations to intercept communications sent in a closed system (e.g., a system configured to enable communication between only specific designated devices), and send supplemental data, generated in response to at least one intercepted communication, to at least one of the closed system devices. The storage device 414 may thus include a computer program product that when executed on the processor-based device 110 causes the processor based device to perform operations to facilitate the implementation of the above-described procedures. The processor-based device may further include peripheral devices to enable input/output functionality. Such peripheral devices may include, for example, a CD-ROM drive and/or flash drive (e.g., a removable flash drive), or a network connection (e.g., implemented using a USB port and/or a wireless transceiver), for downloading related content to the connected system. Such peripheral devices may also be used for downloading software containing computer instructions to enable general operation of the respective system/device.

Alternatively and/or additionally, in some embodiments, special purpose logic circuitry, e.g., an FPGA (field programmable gate array), an ASIC (application-specific integrated circuit), a DSP processor, etc., may be used in the implementation of the system 400. Other modules that may be included with the processor-based device 410 are speakers, a sound card, a pointing device, e.g., a mouse or a trackball, by which the user can provide input to the computing system 400. The processor-based device 410 may include an operating system, e.g., Windows XP® Microsoft Corporation operating system. Alternatively, other operating systems could be used.

Computer programs (also known as programs, software, software applications or code) include machine instructions for a programmable processor, and may be implemented in a high-level procedural and/or object-oriented programming language, and/or in assembly/machine language. As used herein, the term “machine-readable medium” refers to any non-transitory computer program product, apparatus and/or device (e.g., magnetic discs, optical disks, memory, Programmable Logic Devices (PLDs)) used to provide machine instructions and/or data to a programmable processor, including a non-transitory machine readable medium that receives machine instructions as a machine-readable signal.

Some or all of the subject matter described herein may be implemented in a computing system that includes a back-end component (e.g., as a data server), or that includes a middleware component (e.g., an application server), or that includes a front-end component (e.g., a client computer having a graphical user interface or a Web browser through which a user may interact with an embodiment of the subject matter described herein), or any combination of such back-end, middleware, or front-end components. The components of the system may be interconnected by any form or medium of digital data communication (e.g., a communication network). Examples of communication networks include a local area network (“LAN”), a wide area network (“WAN”), and the Internet.

The computing system may include clients and servers. A client and server are generally remote from each other and typically interact through a communication network. The relationship of client and server generally arises by virtue of computer programs running on the respective computers and having a client-server relationship to each other.

Although particular embodiments have been disclosed herein in detail, this has been done by way of example for purposes of illustration only, and is not intended to be limiting with respect to the scope of the appended claims, which follow. In particular, it is contemplated that various substitutions, alterations, and modifications may be made without departing from the spirit and scope of the invention as defined by the claims. Other aspects, advantages, and modifications are considered to be within the scope of the following claims. The claims presented are representative of the embodiments and features disclosed herein. Other unclaimed embodiments and features are also contemplated. Accordingly, other embodiments are within the scope of the following claims.

What is claimed:

1. A system comprising:
an input peripheral device configured to receive transaction data indicative of a transaction including selected items or services;
an output device configured to display or print the transaction data indicative of the transaction including at least one selected item or service;
a point of sale (POS) device comprising:
a processor; and
a memory configured to store computer program code configured to, with the processor, cause the POS device to:
receive an indication of at least one selected item or service from the input peripheral device; and
cause the transaction data to be sent to the output peripheral device to be displayed or printed;
an interfacing unit configured to:
establish serial connectivity between the POS device and at least one of the input peripheral device or the output peripheral device; and
intercept the transaction data being communicated between the POS device and at least one of the input peripheral device and the output peripheral device; and
a monitoring server comprising:
a server processor; and
a server memory configured to store server computer program code configured to, with the server processor, cause the monitoring server to:
receive, in real time, the transaction data from the interfacing unit indicative of at the least one selected item or service;
determine at least one second item or service to be presented to a customer based on information included in the transaction data, about the at least one selected item or service selected by the customer from a plurality of purchasable items, and based on effectiveness measures that are each associated with at least one combination from a set of combinations that each includes the at least one first item or service to be purchased and a corresponding offer of cross-sale of at least one other item from the plurality of purchasable items or services, each of the effectiveness measures being representative of a likelihood that the at least one other item or service to be offered to the customer would be accepted when offered in combination with the at least one first item or service being purchased and computed based on p=s/N, where p represents the likelihood of the cross sale of the respective at least one other item or service when offered in combination with the respective at least one item or service from the plurality of purchasable items or services, s represents a number of successful cross sales over a period of time for the respective at least one other item or service when offered in combination with the respective at least item or service from the plurality of purchasable items or services, and N is the number of times a cross-sale promotion offering the respective at least one other item or services in combination with the respective at least one item or service from the plurality of purchasable items or services has been presented to customers over the period of time;
generate supplemental data based on the determination of the at least one second item or service; and
cause the supplemental data to be transmitted, via the interfacing unit, to the output peripheral device to be displayed or printed,
wherein the input peripheral device, the output peripheral device and the POS device comprise, at least a portion of, a closed system configured to provide communication only between designated closed system devices, and
wherein intercepting the transaction data in the closed system comprises routing the transaction data intercepted in the closed system to the monitoring server not forming part of the closed system.

2. The system of claim 1, wherein the server memory and server computer program code are further configured to, with the server processor, cause the monitoring server to:
generate the supplemental data in response to a determination that the transaction has been completed.

3. The system of claim 1, wherein the POS device includes one or more cash registers to process purchase transactions, the one or more cash registers configured to conform to payment card industry data security standard (PCI DSS).

4. The system of claim 1, further comprising:
a surveillance device configured to associate at least some of the information relating to the transaction with one or more respective images.

5. The system of claim 4, wherein the one or more respective images include images of the POS device, consumers, and cash register operators.

6. The system of claim 1, wherein the output peripheral device comprises a cash register printer configured to print at least some of the transaction data.

7. The system of claim 6, wherein the server memory and server computer program code are further configured to, with the server processor, cause the monitoring server to:
determine that the at least one transaction has been completed; and
cause the cash register printer, via the interface unit, to print the supplemental data on a receipt for the completed transaction, wherein the supplemental data comprises coupon information relating to the transaction.

8. The system of claim 7, wherein the coupon information is generated based on the at least one selected item or service of the transaction data.

9. The system of claim 1, wherein the sever memory and server computer program code are further configured to, with the server processor, cause the monitoring server to:
determine based on the transaction data whether to communicate the supplemental data to the designated closed system devices.

10. The system of claim 1, wherein the sever memory and server computer program code are further configured to, with the server processor, cause the monitoring server to:
determine coupon information based, at least in part, on input received from a user; and
communicate to the output peripheral device the coupon information.

11. The system of claim 10, wherein the supplemental data comprises a plurality of candidate coupons presented to the user, and
wherein the input received from the user comprises a selection of one or more of the candidate coupons.

12. The system of claim 1, wherein the interfacing unit is further configured to:
receive the transaction data;
communicate a copy of the transaction data the monitoring server; and
communicate another copy of the transaction data to one or more of the designated closed system devices.

13. The system of claim 12, wherein the interfacing unit comprises:
a first microcontroller and a second micro controller configured to implement universal serial bus (USB) connectivity between the interfacing unit, the POS device, and at least one of the input peripheral device and output peripheral device.

14. The system of claim 1, wherein the input peripheral device comprises a barcode scanner.

15. The system of claim 1, wherein the supplemental data comprises one or more of information relating to the selected item or service or promotional information generated in response to the selected item or service.

16. The method of claim 1, wherein the supplemental data comprises promotional information about a cross-sale offer to purchase the determined at least one second item or service, wherein the promotional information is displayed on the output peripheral device comprising a user interface or printed on a print medium provided to the customer by the output peripheral device comprising a printer.

17. An interfacing device comprising:
a first microcontroller in data communication with one or more point of sale (POS) devices;
a second microcontroller in data communication with the first microcontroller and one or more peripheral devices, and
a memory configured to store computer program code configured to, with the first microcontroller and second microcontroller, cause the intercept device to:
intercept transaction data in a closed system between one or more peripheral devices and one or more POS devices, wherein the closed system is configured to provide communication between only designated closed system devices, the designated closed system devices including the one or more peripheral devices and the one or more POS devices, wherein the transaction data includes information relating to one or more transactions including at least one selected item or service,
implement serial connectivity between at least one of the one or more POS devices, at least one of the one or more peripheral devices, and a monitoring server of a monitoring system, wherein the monitoring server is not part of the closed system; and
route the transaction data to the monitoring server,
wherein the monitoring server comprises:
a server processor; and
a server memory configured to store server computer program code configured to,
with the server processor, cause the monitoring server to:
receive, in real time, the transaction data from the interfacing unit indicative of at the least one selected item or service;
determine at least one second item or service to be presented to a customer based on information included in the transaction data, about the at least one selected item or service selected by the customer from a plurality of purchasable items, and based on effectiveness measures that are each associated with at least one combination from a set of combinations that each includes the at least one first item or service to be purchased and a corresponding offer of cross-sale of at least one other item from the plurality of purchasable items or services, each of the effectiveness measures being representative of a likelihood that the at least one other item or service to be offered to the customer would be accepted when offered in combination with the at least one first item or service being purchased and computed based on p=s/N, where p represents the likelihood of the cross sale of the respective at least one other item or service when offered in combination with the respective at least one item or service from the plurality of purchasable items or services, s represents a number of successful cross sales over a period of time for the respective at least one other item or service when offered in combination with the respective at least item or service from the plurality of purchasable items or services, and N is the number of times a cross-sale promotion offering the respective at least one other item or services in combination with the respective at least one item or service from the plurality of purchasable items or services has been presented to customers over the period of time;
generate supplemental data based on determination of the at least one second item or service; and
cause the supplemental data to be transmitted, via the interfacing unit to a peripheral device of the one or more peripheral devices to be displayed or printed.

18. The interfacing device of claim 17, wherein the serial connectivity comprises universal serial bus (USB) connectivity between the interfacing unit, the one or more POS devices, and one or more peripheral devices.

19. The interfacing unit of claim 17, the supplemental data is generated and transmitted in response to a determination that the transaction has been completed.

20. The interfacing device of claim 17, wherein the one or more POS devices comprise one or more cash registers to process purchase transactions, the one or more cash registers configured to conform to payment card industry data security standard (PCI DSS).
